(19) United States
(12) Patent Application Publication
(10) Pub. No.: US 2005/0163368 A1
(43) Pub. Date: Jul. 28, 2005

(54) Image processing apparatus and method therefor

(76) Inventor: Takashi Hanamoto, Kawasaki-shi (JP)

Correspondence Address: MORGAN & FINNEGAN, L.L.P., 3 WORLD FINANCIAL CENTER, NEW YORK, NY, 10281-2101, US

(21) Appl. No.: 11/044,701

(22) Filed: Jan. 27, 2005

(30) Foreign Application Priority Data
Jan. 28, 2004 (JP) 2004-020386

(51) Int. Cl. G06K 9/00

(52) U.S. Cl. 382/162; 382/168

(57) ABSTRACT

The apparatus according to the invention displays a display area for displaying the conversion curve indicating a relation between input pixel value and output pixel value and a window having a slider bar. The user can adjust the conversion curve moving a knob of the slider bar. In addition, the conversion curve can be changed by changing the position of one of the plurality of index axes that define the conversion curve in the display area. When the position of an index axis is changed and the conversion curve is adjusted, the state of the slider bar is also revises based on the post-adjustment conversion curve.

### FIELD OF THE INVENTION

The present invention concerns a technology for processing image data.

### BACKGROUND OF THE INVENTION

In recent years, with the appearance of printers that connect directly to a digital camera, the operation of printing an image has been simplified.

By contrast, however, where the brightness or contrast of the image has been deliberately adjusted and modified, it is necessary to edit the image on a personal computer (“PC”).

Here, in order to facilitate the understanding of the present invention, a description will now be given of an application to be executed on a PC.

Most typical applications that process image data for brightness and contrast (such as, for example, that disclosed in Japanese Laid-Open Patent Publication No. 2001-57663) have a GUI (Graphical User Interface) comprising a brightness slider bar and a contrast slider bar, and adjust the brightness and contrast by adjusting the position of the slide on the slider bar.

However, under the existing brightness and contrast adjustment regime, these two adjustments are made independently of each other, and thus, for example, a phenomenon arises in which, when the contrast was increased, the brightness of the image further increased. In other words, despite having set the image to a target brightness, adjusting the contrast also changes the brightness. As a result, it is impossible to obtain the desired brightness and contrast without alternately adjusting the brightness and contrast multiple times. This situation arises because of the correlation between brightness and contrast, and because what kinds of changes are made to the image data by changing the brightness and contrast is not clearly understood by the user.

### SUMMARY OF THE INVENTION

An object of the present invention is to overcome the above-described drawbacks. Another object is to provide a user interface technology in which a user can easily adjust brightness and contrast.

In an aspect of the present invention, the present invention provides an image processing apparatus comprising:
conversion curve display means for displaying a conversion curve showing a relation between an input image value and an output image value in a predetermined display area;
first adjustment means for adjusting the conversion curve using a slider bar provided outside the display area and revising a displayed conversion curve;
second adjustment means for adjusting the conversion curve by changing the position of one of a plurality of index axes, inside the display area, defining the conversion curve and updating the displayed conversion curve; and
revision means for revising a slider bar state based on the conversion curve if the conversion curve is adjusted by the second adjustment means.

Other features, objects and advantages of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the major compositional elements of an image processing apparatus, according to an embodiment of the present invention;

FIG. 2 is a diagram showing a GUI window in the present embodiment;

FIGS. 3A, 3B and 3C are diagrams illustrating a tone curve conversion process in the present embodiment;

FIGS. 4A, 4B and 4C are diagrams showing an example of a tone curve state in a case in which a brightness slider bar has been manipulated;

FIGS. 5A, 5B and 5C are diagrams showing an example of a tone curve state in a case in which a contrast slider bar has been manipulated;

FIGS. 6A and 6B are diagrams showing examples of tone curve states;

FIG. 7 is a diagram showing an example of a tone curve state in the present embodiment;

FIGS. 8A and 8B are flow charts showing a processing procedure in a case in which the brightness slider bar is manipulated;

FIG. 9 is a flow chart showing a brightness slider bar revise processing procedure in a case in which manipulation is on the tone curve;

FIG. 10 is a flow chart showing a processing procedure in a case in which the contrast slider bar is manipulated;

FIG. 11 is a flow chart showing a contrast slider bar revision processing procedure in a case in which manipulation is on the tone curve;

FIGS. 12A and 12B are diagrams illustrating the principle of reflecting brightness adjustment results in the tone curve;

FIGS. 13A and 13B are diagrams illustrating the principle of reflecting contrast adjustment results in the tone curve;

FIGS. 14A and 14B are diagrams illustrating a tone curve expansion/compression process;

FIG. 15A and 15B are diagrams showing examples of a display of a tone curve area of the GUI window; and

FIG. 16 is a flow chart showing the main routine of an image adjustment process of the present embodiment.

### DETAILED DESCRIPTION OF THE PREFERRED EMBODIMENTS

Preferred embodiments of the present invention will now be described in detail according to the accompanying drawings.

<Description of the Apparatus Configuration>

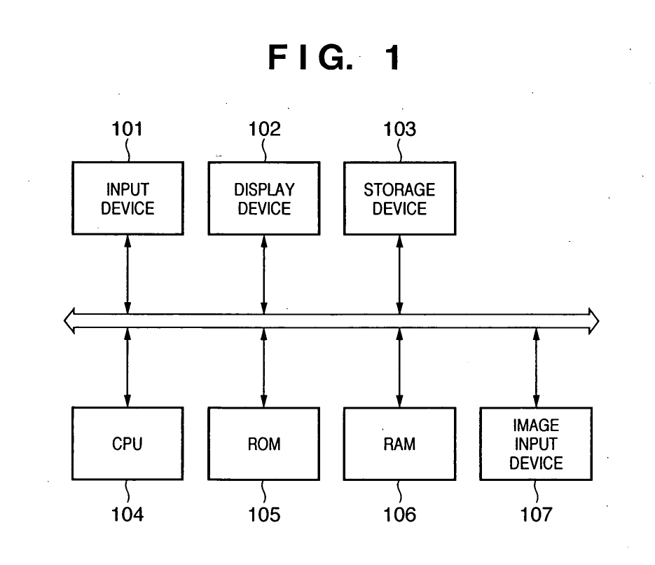

FIG. 1 is a block diagram showing the major compositional elements of an image processing apparatus, according to an embodiment of the present invention. It should be noted that the apparatus shown in FIG. 1 can be achieved by, for example, a personal computer.

In FIG. 1, reference numeral 101 denotes an input device for inputting data and instructions from a user, and includes a keyboard as well as a pointing device such as a mouse. Reference numeral 102 denotes a display device that displays a GUI for manipulating an image editing application of the present embodiment. The display device 102 may be a CRT, an LCD or the like. Reference numeral 103 denotes a storage device that stores the OS and a plurality of applications (including the image editing application of the present embodiment), as well as image files in a variety of formats. The storage device 103 may be a hard disk. Reference numeral 104 denotes a CPU (Central Processing Unit), which exerts control of the entire apparatus according to a program. Reference numeral 105 denotes a ROM (Read Only Memory) storing a BIOS (Basic Input/Output System) and a boot program and reference numeral 106 denotes a RAM (Random Access Memory) that is used as a work area by the CPU 104. When power is supplied to the apparatus, the CPU 104, in accordance with boot program in the ROM 105, loads the OS stored in the storage device 103 into the RAM 106 and executes it. After the OS has been started up, the CPU 104 loads the image editing application from the storage device 103 to the RAM 106 and executes it. Reference numeral 107 denotes an image input device for inputting images. If in communication with a digital camera, the image input device 107 may be a USB interface, or If in communication with a memory card, the device 107 may be an interface that connects a memory card. If inputting image data from a network, the image input device 107 may be a network interface. If scanning a document image, the image input device 107 may be an interface that connects an image scanner.

It should be noted that the image processing apparatus configuration shown in FIG. 1 is merely one example thereof, and the present invention is not limited thereto. Moreover, in the above-described configuration, the image processing apparatus is started up, and executes the image editing application of the present embodiment.

<Description of Image Adjustment>

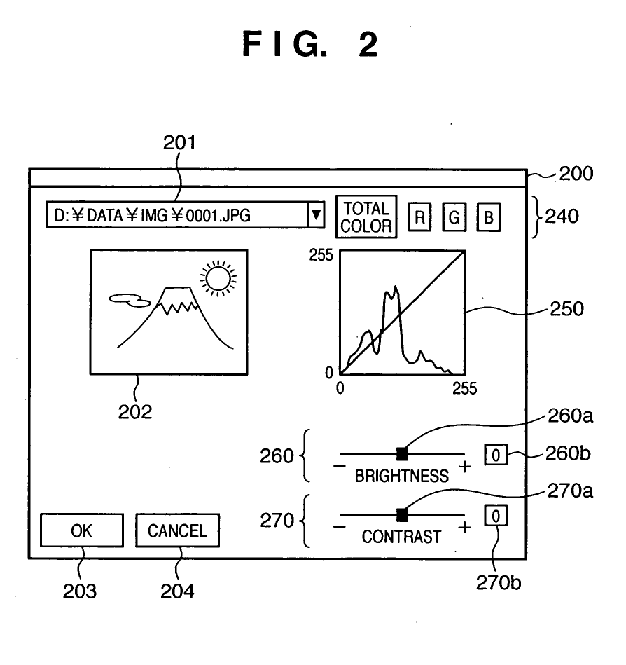

FIG. 2 is a diagram showing a GUI (Graphical User Interface) for manipulating the image editing application of the present embodiment.

In FIG. 2, reference numeral 200 denotes a window that is an adjustment-use GUI. In the window 200 there is provided an area 201 which is used for designating information (a path and a file name) indicating the image file that is to be converted as well as an image display region 202 to which an image decoded from the specified image file is displayed. Reference numeral 203 denotes an OK button that actually carries out the conversion process on the specified image file and reference numeral 204 denotes a cancel button that cancels the conversion. The functions of each of these buttons are executed by positioning a cursor, which linked to the input device 101, on a button and clicking.

In addition, reference numeral 240 denotes a color component selection area, and is composed of four buttons: Total color, R (red), G (green) and B (blue). The user moves a cursor linked to the input device 101 and specifies (clicks) the desired button to select the color component to be changed. It should be noted that the default selection state is “total color”.

Reference numeral 250 denotes a tone curve area that displays a tone curve corresponding to total color, R, G and B (the tone curve being also a conversion curve of a conversion table), reference numeral 260 denotes a brightness slider bar for adjusting the brightness of selected color(s) and reference numeral 270 denotes a contrast slider bar for adjusting the contrast of selected color(s). In the present embodiment, adjustment of the total color, R, G and B is possible by manipulating any one of the tone curve area 250, the brightness slider bar 260, or the contrast slider bar 270.

It should be noted that, in the tone curve area 250 of the present embodiment, histograms of the color components (in the present embodiment, R, G, B) of the image file designated by the user are displayed in such a way as to overlap the tone curve. It should also be noted that the histograms that are displayed are unrelated to the colors designated by the color component selection area, and are displayed so that the luminance of each of the colors R, G, B is always shown on the horizontal axis, and the frequency is shown on the vertical axis. However, alternatively, the embodiment may be configured so as to display only the histogram of the color component designated in the color component selection area 240. The reason why the histograms are displayed is that it becomes an index when adjusting the tone curve of the color components. The histograms are displayed in the tone curve area 250 so that the user can carry out adjustment of the tone curve that is described below without frequently changing his or her viewing position.

A more detailed description will now be given of the tone curve area 250 of the present embodiment.

The tone curve area 250 of the present embodiment is substantially square, with the horizontal axis representing input pixel value (which is also the pixel value before correction) and the vertical axis representing output pixel value (which is also the pixel value after correction), each with a range of 0-255. In other words, each color components R, G, B is expressed in 8-bit units.

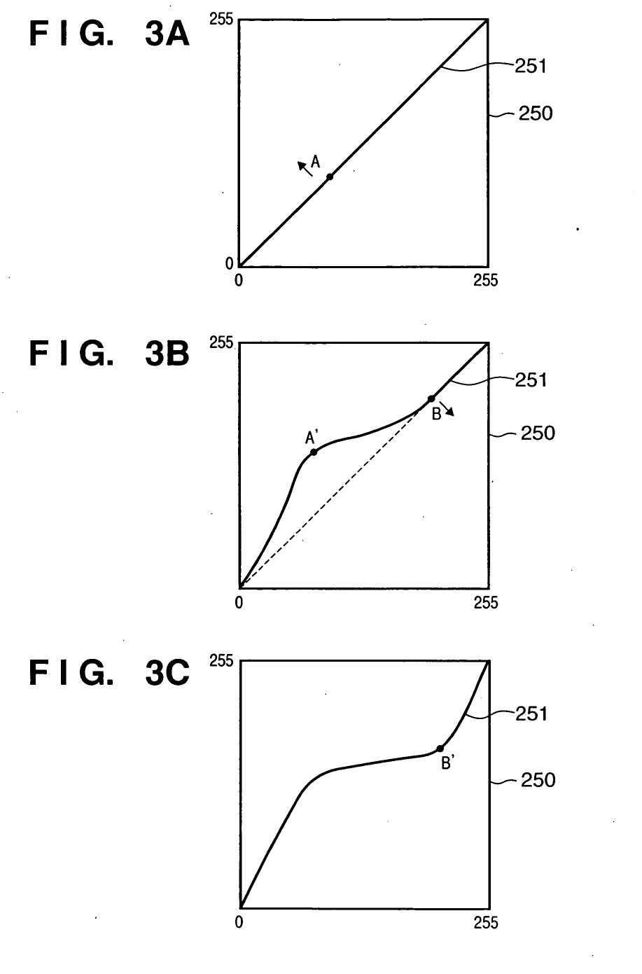

FIG. 3A shows details of the tone curve area 250, which in this case is also an initial state. It should be noted that although a histogram is also superimposed as described above, in the following description, the histograms of every color are omitted for simplicity of explanation.

In FIG. 3A, reference numeral 251 denotes a tone curve corresponding to total color, R, G and B. In an initial state, the tone curve is a straight line, thus indicting that the relation “input pixel value=output input value” is maintained. Here, if, for example, the user operates the input device 101 to move a point A on the tone curve 251 to a point A′, the user can change the tone curve 251 to the state shown in FIG. 3B. Moreover, by moving the point B in FIG. 3B to a point B′, the user can also change the tone curve 251 to the state shown in FIG. 3C. When the tone curve 251 is changed, the input-output relation also changes, and therefore the color tone in the image display region 202 also changes in response. In changing the shape of the tone curve, for example, the change from the state shown in FIG. 3A to that shown in FIG. 3B, when point A is moved to point A′, the closer to point A along the tone curve 251, the more such portion is corrected so as to be affected by point A′ after the move. The same holds true of the move from point B to point B′. Therefore, the user can freely change the shape of the tone curve 251. It should be noted that if the tone curve 251 is a gamma curve, a slider bar for setting a parameter defining the gamma curve may be provide.

Next, a description will be given of the relation between the brightness slider bar 260, the contrast slider bar 270 and the tone curve 251.

The brightness slider bar 260 is composed of a knob 260a movable in a horizontal direction (subject to manipulation by the user) and an area 260b that displays the amount of correction depending on the current position of the knob 260a. In an initial state, the knob 260a is located at the center of the slider bar, and thus the correction amount area 260b shows “0”. When the knob 260a is moved to the right, the number displayed in the correction amount area 260b increase. Conversely, when the knob 260a is moved to the left, the number displayed in the correction amount area 260b decreases (that is, becomes negative).

The foregoing option is the same for the contrast slider bar 270. That is, when the position of a knob 270a is changed, the number displayed in a correction amount area 270b also changes accordingly. A specific example thereof is described below.

Before proceeding to the following description, the terms will be defined as follows.
(1) Output Pixel Maximum Value (OUT_MAX): The maximum value in the range of the output pixel values converted by the tone curve 251.
(2) Output Pixel Minimum Value (OUT_MIN): The minimum value in the range of output pixel values changed by the tone curve 251.
(3) Input Pixel Highlight Value (IN_HLT): The minimum value of an input pixel value that becomes the “output pixel maximum value”. In other words, if the input pixel value is greater than this value, the input pixel value is converted to the “output pixel maximum values”.
(4) Input Pixel Shadow Value(IN_SDW): The maximum value of an input pixel value that becomes the “output pixel minimum value”. In other words, if the input pixel values is smaller than this value, the input pixel value is converted to “output pixel minimum values”).

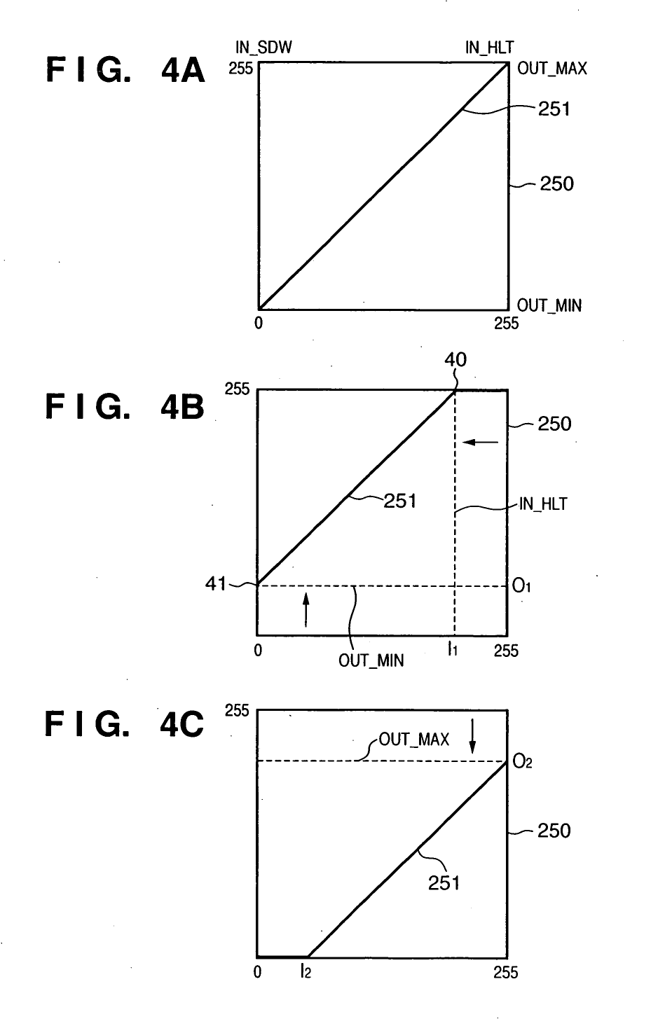

FIGS. 4A, 4B and 4C are diagrams showing changes in the tone curve 251 when the brightness slider bar 260 is manipulated. FIG. 4A also depicts a case in which the OUT_MAX=255, the OUT_MIN=0, the IN_HLT=255 and the IN_SDW=0. The tone curve 251 is the straight line default.

When the knob 260a of the brightness slider bar 260 is moved to the right (in the “+” direction) by the user's operation, the tone curve 251 moves upward as shown in FIG. 4B. In the case of FIG. 4B, IN_HLT=I₁, IN_SDW=0, OUT_MAX=255 and OUT_MIN=O₁.

By contrast, FIG. 4C shows the tone curve 251 in a case in which the brightness has been decreased, in other words, the knob 260a of the brightness slider bar 260 has been moved to the left (in the “−” direction). In the case of FIG. 4C, IN_HLT=255, IN_SDW=I₂, OUT_MAX=O₂ and OUT_MIN=0.

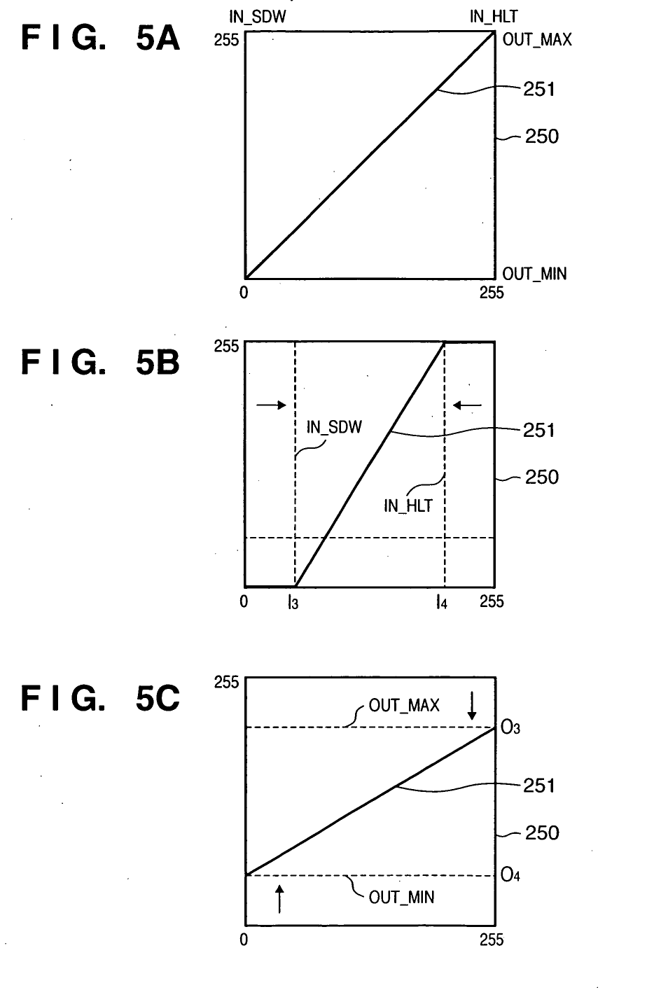

FIGS. 5A, 5B and 5C are diagrams showing changes in the tone curve 251 when the contrast slider bar 270 is manipulated. FIG. 5A shows the initial state of the tone curve 251.

When the knob 270a of the contrast slider bar 270 is moved to the right (+direction), as shown in FIG. 5B, the slope of the tone curve 251 increases, IN_SDW=I₃ and IN_HLT=I₄. Moreover, OUT_MAX=255 and OUT_MIN=0, there is no change from the state shown in FIG. 5A.

If in the state shown in FIG. 5A the knob 270a of the contrast slider bar 270 is moved to the left (−direction), then the slope of the tone curve 251 decreases as shown in FIG. 5C. In the case of the state shown in FIG. 5C, IN_SDW=0 and IN_HLT=255 and hence there is no change from the state shown in FIG. 5A. However, OUT_MAX=O₃ and OUT_MIN=O₄.

The foregoing description relates to instances in which either the brightness slider bar 260 or the contrast slider bar 270 is manipulated. The following description relates to instances in which both slider bars are operated.

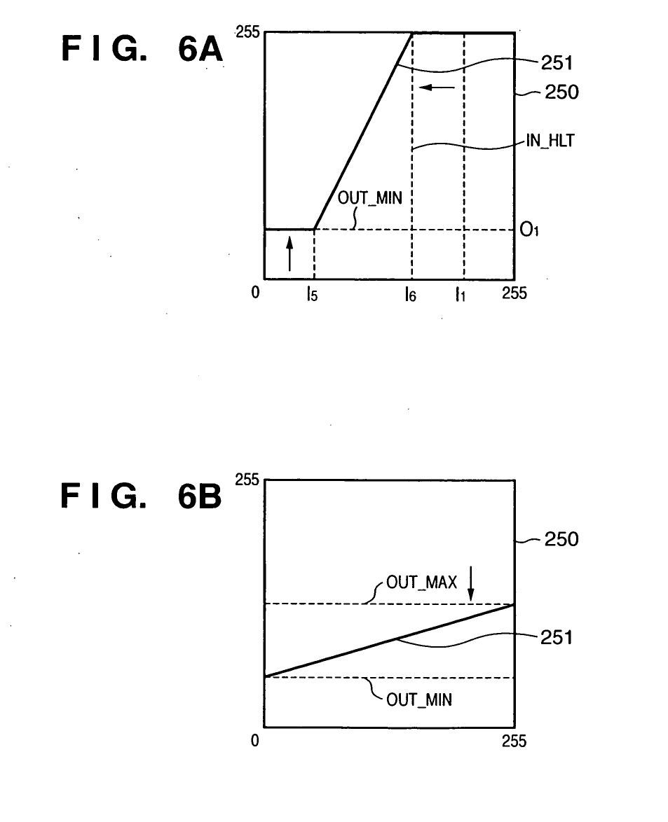

For example, in the state shown in FIG. 4B, the act of increasing the contrast (that is, moving the knob 270a of the contrast slider bar 270 to the right) means increasing the slope of the unsaturated slanted line portion, for example as shown in FIG. 6A.

Accordingly, the four parameters of FIG. 4B, that is, IN_HLT=I₁, IN-SDW=0, OUT_MAX=255 and OUT_MIN=O₁, in FIG. 6A become IN_HLT=I₆, IN_SDW=I₅, OUT_MAX=255 and OUT_MIN=O₁.

It should be noted that, as can be easily understood, the state shown in FIG. 6A is similar to which the brightness is increased in a state shown in FIG. 5B.

Moreover, FIG. 6B shows an instance in which the contrast is decreased in the state shown in FIG. 4B (that is, the knob 270a of the contrast slider bar 270 is moved to the left).

The foregoing description pertains to changes in the tone curve 251 as the brightness slider bar 260 and the contrast slider bar 270 are manipulated in the present embodiment. Conversion according to the tone curve 251 of the present embodiment can be summarized as follows.

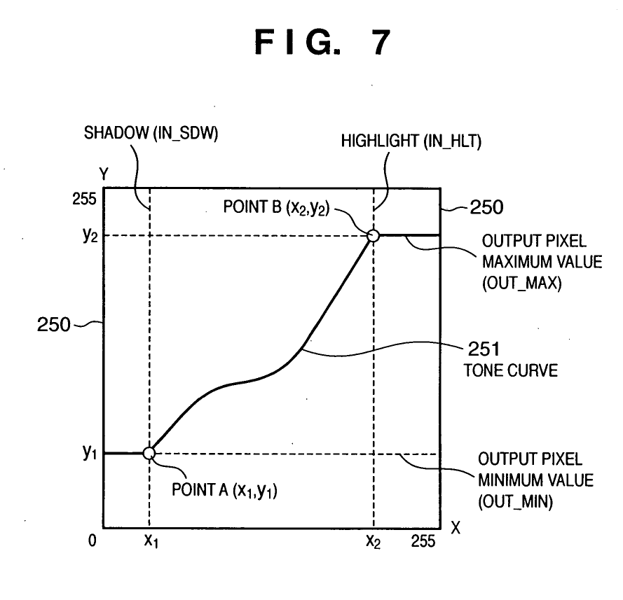

As shown in FIG. 7, the intersection of the IN_SDW line (the vertical line) and the OUT_MIN line (horizontal line) is defined as point A (x1, y1) and the intersection of the IN_HLT line (vertical line) and the OUT_MAX line (horizontal line) is defined as point B (x2, y2). When the input pixel value is D, then,
i. if D<IN_SDW(x1), the value of output pixel is fixed at y1;
ii. if IN_SDW≦D≦IN_HLT(x2), the value of output pixel depends on tone curve (shape) 251 connecting points A and B; and
iii. if IN_HLT<D, the value of output pixel is fixed at y2.

It should be noted that, as described above, the shape of the tone curve 251 connecting points A-B can be changed. Thus, by adjusting the brightness slider bar 260 and the contrast slider bar 270, that shape can be expanded/compressed along to a horizontal direction or a vertical direction. A description of that expansion/compression processing is given below.

<Processing Using the Brightness Slider Bar>

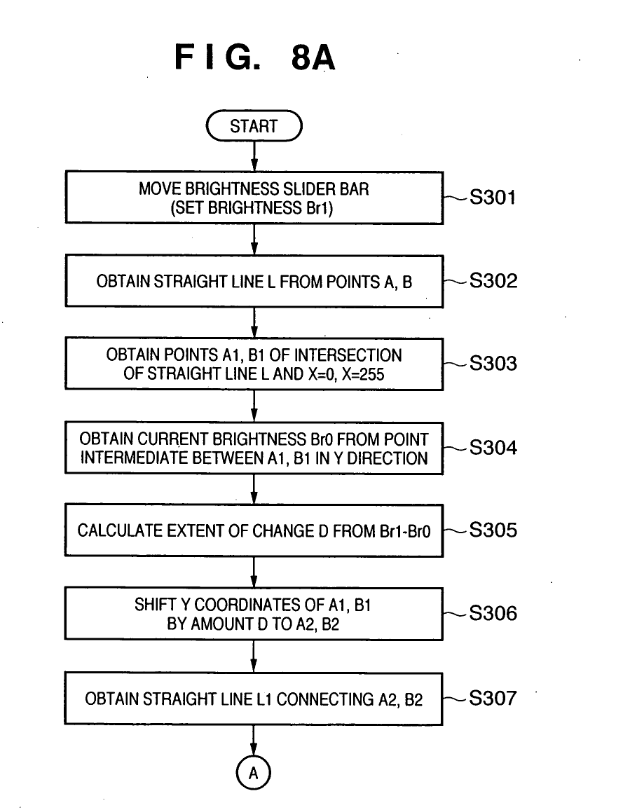

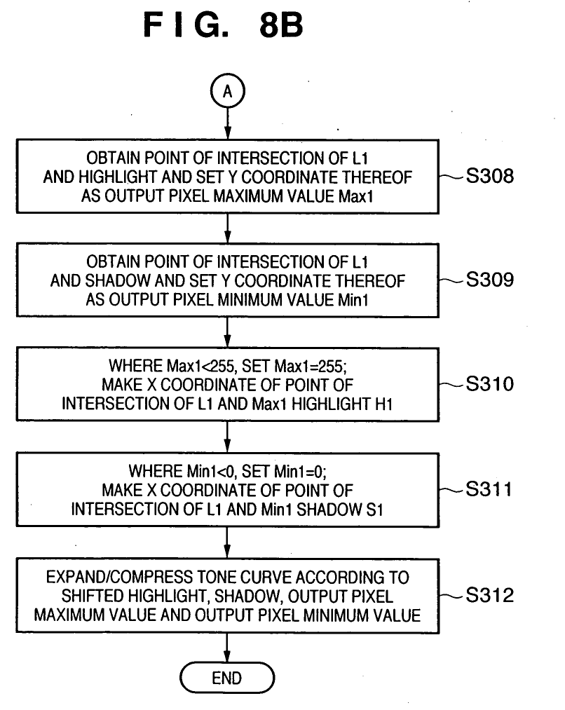

A description will now be given of processing when the brightness slider bar is manipulated, referring to FIGS. 8A and 8B. The processes shown in FIGS. 8A and 8B are executed by the CPU 104 according to the image editing application.

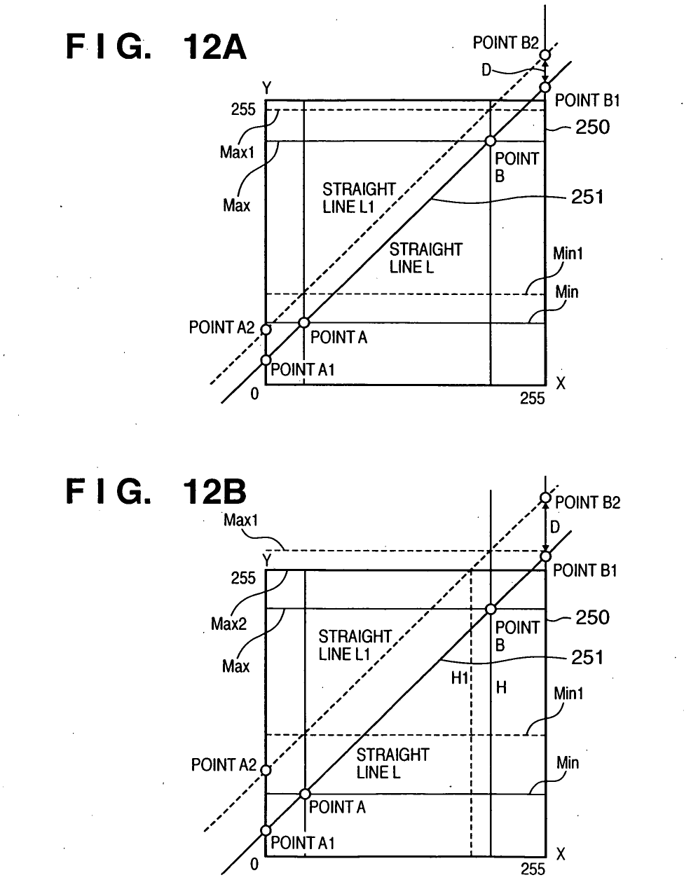

First, in step S301, a new brightness level Br1 is determined according to the movement of the brightness slider. In step S302, the coordinate of the point A of intersection of the line represented by the IN_SDW and the line represented by OUT_MIN shown in FIG. 12A is calculated, the coordinate of the point B of intersection of the line represented by the IN_HLT and the line represented by OUT_MAX is calculated, and a function representing a line L connecting the two points A, B is obtained.

Next, in step S303, the coordinate of a point A1 of intersection between the straight line L and x=0 and the coordinate of a point B1 of intersection between the straight line L and x=255 are obtained. In step S304, a current brightness Br0 is obtained. Since the brightness of the tone curve can be defined by the y coordinate intermediate between points A1 and B1, the “Br0” may be obtained therefrom. In step S305, an amount of change D in the brightness is calculated from the difference between Br1 and Br0. In step S306, the positions of a point A2 and a point B2, to which the Y coordinates of points A1 and B1 are shifted by an amount D, are calculated. In a step S307, the straight line L1 connecting points A2 and B2 is calculated (see FIG. 12A). In step S308, the intersection of the straight line L1 and the line represented by IN_HLT is calculated, the y coordinate Max1 thereof is set as a new OUT_MAX so that the line represented by OUT_MAX is moved to that new position.

In step S309, the intersection of the straight line L1 and the line represented by IN_SDW is calculated, the y coordinate Min1 thereof is set as a new OUT_MIN so that the line represented by OUT_MIN is moved to that new position.

In step S310, as shown in FIG. 12B, processing where Max1>255 is performed. If Max1>255, Max1 is set to “255” and made Max2. Then, the x coordinate H1 of the intersection of Max2 and the straight line L1 is made a new IN_HLT so that the line represented by IN_HLT is moved to that new position.

In a step S311, if Min1<0, Min1 is set to “0” and that position is made Min2. Then, the x coordinate S1 of the intersection of the Min2 and the straight line L1 is set as a new IN_SDW so that the line represented by IN_SDW is shifted to the position of S1.

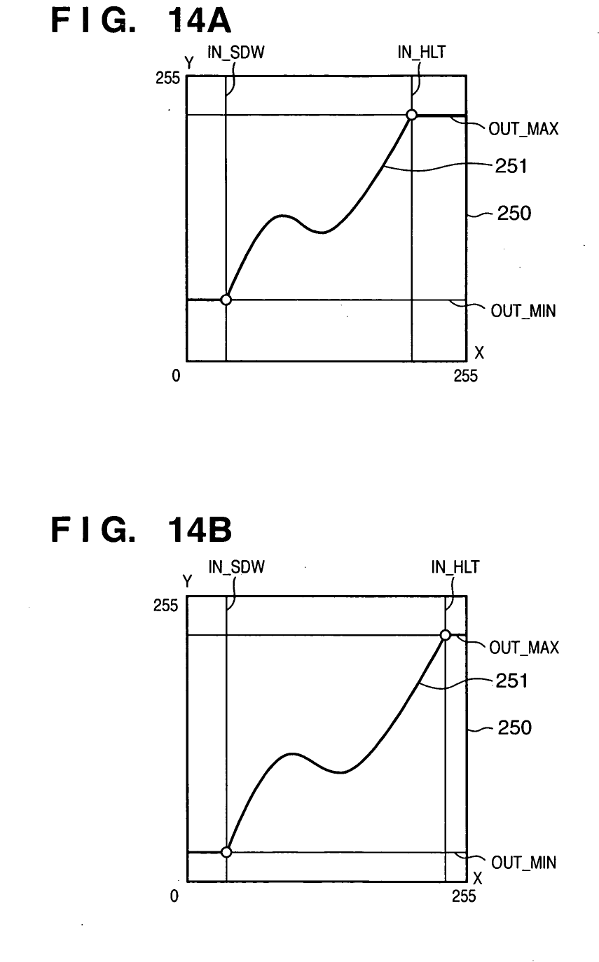

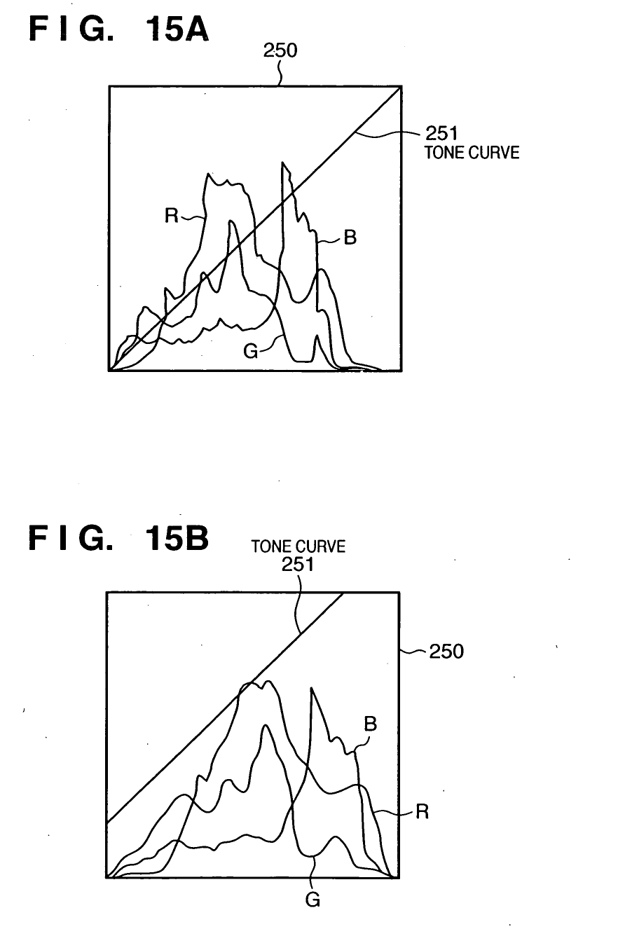

In a step S312, the tone curve 251 is expanded/compressed in real time according to the lines of the post-shift IN_HLT, IN_SDW, OUT_MAX and OUT_MIN. Expansion/compression involves expanding or compressing the tone curve 251 horizontally or vertically while maintaining the shape of the curve, as shown, for example, in the shift from the state shown in FIG. 14A to the state shown in FIG. 14B. Furthermore, the CPU 104 recalculates the histogram of each color component and displays those results, together with the post-conversion tone curve 251, in the tone curve area 250 in real time.

<Manipulating the Brightness on the Tone Curve>

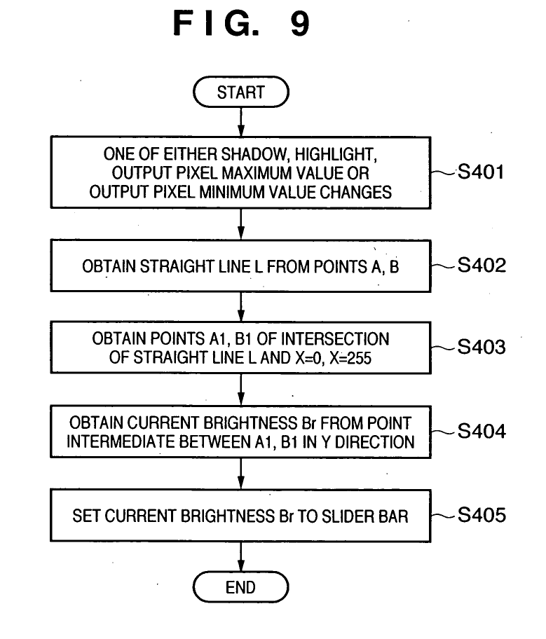

The foregoing description concerns changing the brightness by moving the knob 260a of the brightness slider bar 260 to the left or right. Below, a description is given, referring to FIG. 9, of an instance in which, when the position of one of the lines represented by IN_HLT, IN_SDW, OUT_MAX and OUT_MIN is changed, and that change is reflected in the brightness slider bar 260.

In an initial state, each of the four parameters (IN_HLT, IN_SDW, OUT_MAX and OUT_MIN) corresponds to each of the four sides of the outer frame of the tone curve area 250, and is a coordinate axis having the meaning described above.

The user specifies one of the four sides of the tone curve area 250 using the input device 101, and can move the specified axis to a desired position within the tone curve area 250 by dragging operation. It should be noted that, because the parameters are either horizontal or vertical lines, such movement maintains these characteristics unchanged. For example, if the user clicks on the right edge of the tone curve area 250, a handler is displayed that indicates that the line represented by IN_HLT can be moved. By dragging the handler, the line represented by IN_HLT can be moved along to the horizontal direction within the tone curve area 250. Then, if necessary, all four parameter lines cam be moved.

The process Illustrated in FIG. 9 is executed by the CPU 104 according to the image editing application.

Initially, in step S401, the user shifts one of lines of IN_HLT, IN_SDW, OUT_MAX and OUT_MIN. At this time, either point A or point B shifts, and the tone curve 251 between points A and B is expanded or compressed as well, and displayed and revised in real time. Furthermore, the CPU 104 recalculates the histogram of each color component and displays the results of those recalculations in real time, together with the post-conversion tone curve 251, in the tone curve area 250.

In step S402, the straight line L is calculated from points A, B shown in FIG. 12A. In step S403, points A1 and B1, corresponding to the points on the straight line L where x=0 and x=255, are obtained. Then, in step S404, the brightness Br is calculated from the y coordinate of a point intermediate between points A and B1.

In a step S405, the position of the knob 260a of the brightness slider bar 260 is revised in accordance with the value for the obtained brightness Br.

Thus, as described above, according to the present embodiment, when moving the knob 260a of the brightness slider bar 260 for adjusting the brightness, the results of that adjustment are reflected in the tone curve 251 in real time, so that it is possible to grasp visually in what kind of state is the brightness. In addition, whenever the user moves one of lines represented by IN_HLT, IN_SDW, OUT_MAX and OUT_MIN, the brightness level achieved thereby is reflected in the position of the knob 260a of the brightness slider bar 260, thus enabling the user to grasp simply and directly how his or her action has affected the brightness.

<Processing Using the Contrast Slider Bar>

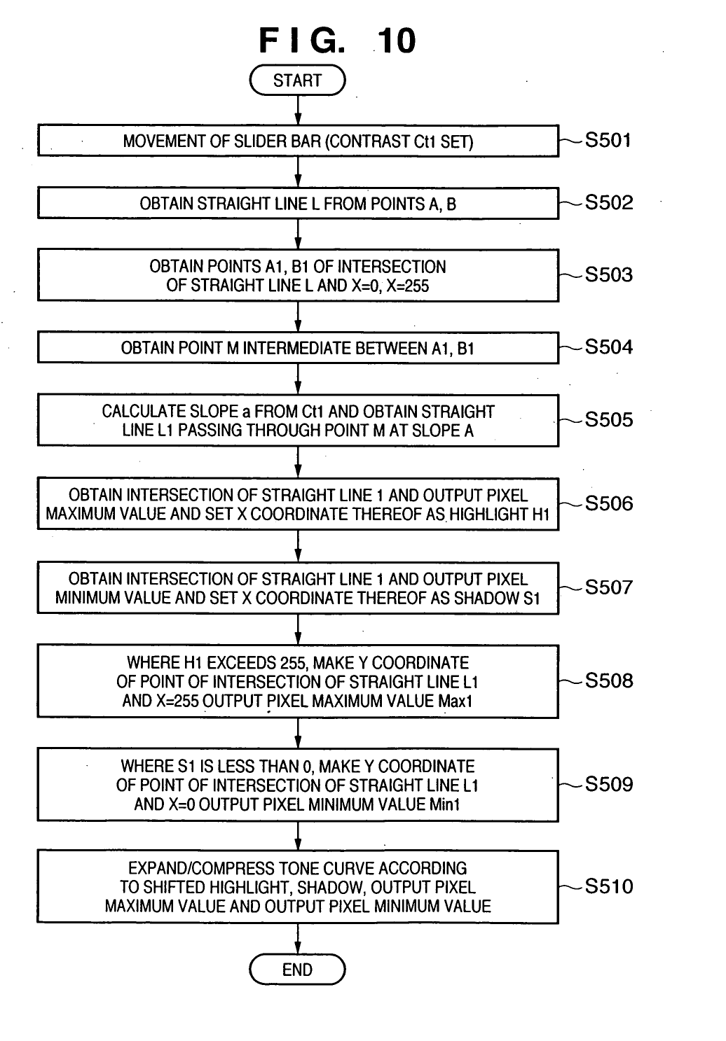

Next, referring to FIG. 10, a description will be given of an instance in which the contrast adjustment and the tone curve 251 of the present embodiment are linked.

The process illustrated in FIG. 10 is executed by the CPU 104 according to the image editing application.

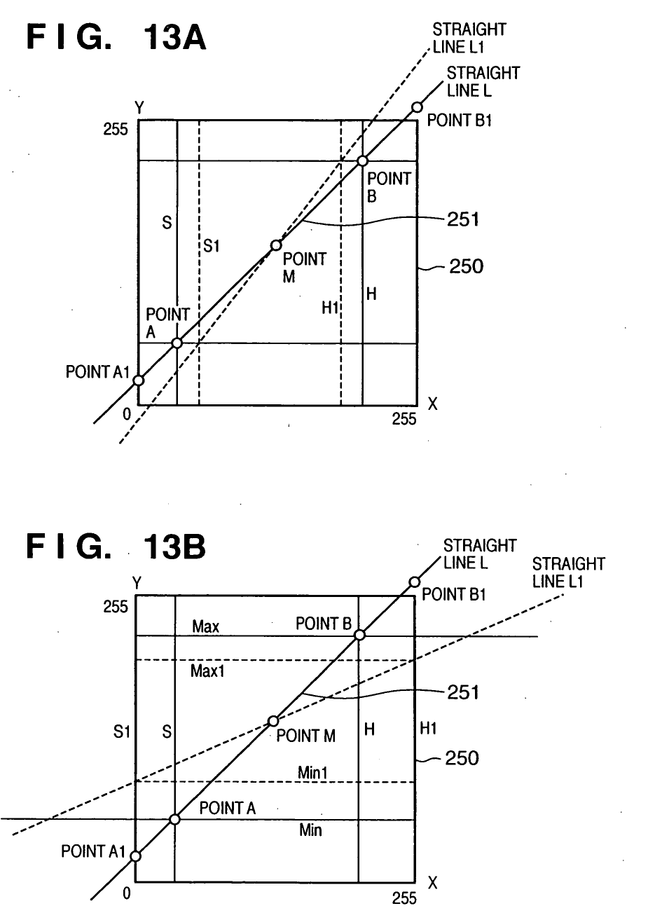

First, in step S501, a new contrast level Ct1 is determined from the position the knob 270a of the contrast slider bar 270. Next, in step S502, the coordinate of the point A of intersection of the line of IN_SDW and the line of OUT_MIN shown in FIG. 13A is calculated, the coordinate of the point B of intersection of the line of IN_HLT and the line of OUT_MAX is also calculated, and a line L connecting the two points A, B is obtained. Next, in step S503, a point A1 of intersection between the straight line L and x=0 and a point B1 of intersection between the straight line L and x=255 are obtained. In step S504, a point M intermediate between point A1 and point B1 is obtained. In step S505, a new line is calculated from Ct1. The relation between the contrast (Ct) and the slope of the straight line L is given by the following equation:
a=tan(Ct*π/2/255).
By this equation, a slope a1 of the new line is calculated from Ct1, as a straight line L that passes through point M is calculated. In step S506, the intersection of the straight line L1 and the line of OUT_MAX is obtained and the x coordinate H1 thereof is made a new IN_HLT so that the line of IN_HLT is moved to the x coordinate H1.

In step S507, the intersection of the straight line L1 and the line of OUT_MIN is obtained and the x coordinate S1 thereof is made a new IN_SDW so that the line of IN_SDW is moved to the x coordinate S1.

In step S508, as shown in FIG. 13B, if H1>255, H1 is set to “255” and the position thereof is made as H2. Then, the y coordinate of the intersection Max1 of the line of H2 and the straight line L1 is made a new OUT_MAX so that the line of OUT_MAX is moved to the y coordinate Max1.

In step S509, as shown in FIG. 13B, if S1<0, S1 is set to “0” and its position becomes S2. Then, the y coordinate Min1 of the intersection of the line S2 and the straight line L is made a new OUT_MIN so that the line of OUT_MIN is moved to the y coordinate Min1.

Finally, in step S510, the tone curve 251 is expanded or compressed in real time in accordance with the post-movement lines of IN_HLT, IN_SDW, OUT_MAX and OUT_MIN. Furthermore, the CPU 104 recalculates the histogram of each color component and displays the results of those recalculations in real time, together with the post-conversion tone curve 251, in the tone curve area 250.

<Manipulating the Contrast on the Tone Curve Area>

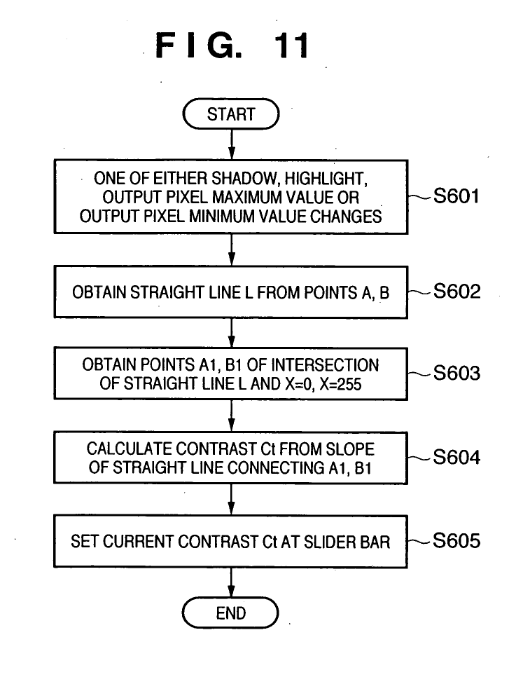

Adjusting of the contrast is possible not only with the contrast slider bar 270 described above but also where one lines of IN_HLT, IN_SDW, OUT_MAX or OUT_MIN is shifted. This process is described using FIG. 11. The process illustrated in FIG. 11 is executed by the CPU 104 according to the image editing application.

First, in step S601, the user shifts one of lines of IN_HLT, IN_SDW, OUT_MAX and OUT_MIN. As a result, one of either point A or point B also shifts, and the tone curve 251 also expands or compresses in response thereto and is displayed in its newly revised form. Furthermore, the CPU 104 recalculates the histogram of each color and displays the results of those recalculations in real time together with the post-conversion tone curve 251 in the tone curve area 250.

In step S602, the straight line L is calculated from points A, B on the tone curve 251 shown in FIG. 12A. In step S603, points A1 and B1, which are the intersections of the straight line L with x=0 and x=255, are obtained.

In step S604, a new contrast Ct is calculated from the slope of the line connecting points A, B1, using the following formula, with the coordinates of A1 being (X1, Y1) and the coordinates of B1 being (X2, Y2), then
Ct=a tan((Y2-Y1)/(X2-X1)/(π/2)*255).

In step S605, in accordance with the value for the contrast Ct obtained as described above, the position of the knob 270a of the contrast slider bar 270 is changed and the display is revised.

Thus, as described above, where the tone curve is changed by the contrast slider bar 270, the user can grasp the extent to which the contrast has changed depending on the position of the knob 270a. Furthermore, the movement of one of either the IN_HLT, IN_SDW, OUT_MAX or OUT_MIN is reflected in the position of the knob 270a, the contrast can be set at will, and confusion on the user interface can be reduced.

It should be noted that adjustment of the brightness and contrast is carried out only with respect to the color component selected using the color component selection area 240 shown in FIG. 2.

Moreover, if the position of one of lines of IN_HLT, IN_SDW, OUT_MAX and OUT_MIN is changed, of course, there is possibility that the results thereof affects both brightness and contrast. Therefore, when the process shown in FIG. 9 is actually finished, processing proceeds to that shown in FIG. 11. Alternatively, the order may be reversed.

<Description of the Main Process>

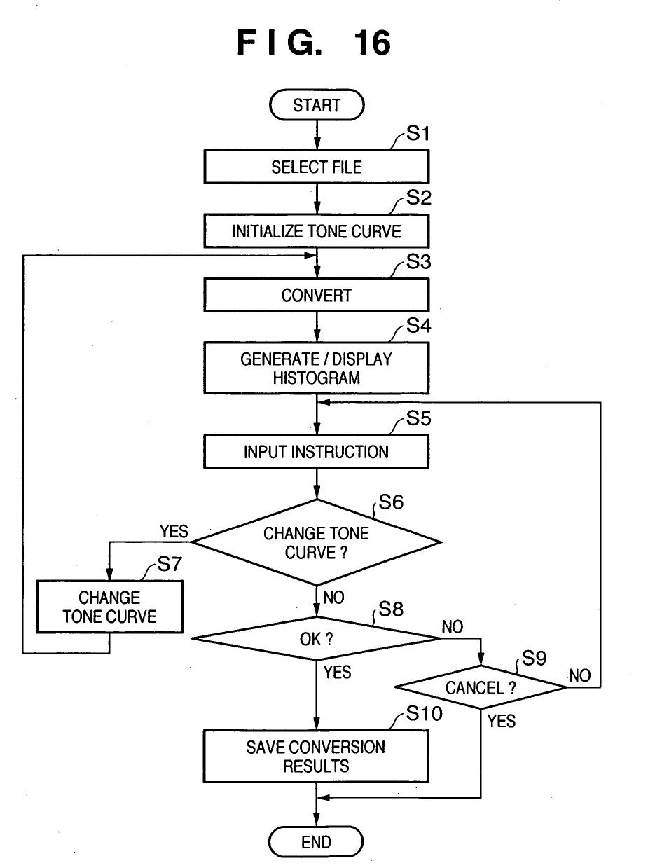

Next, a description will be given of the main process that the CPU 104 of the present embodiment executes according to the image editing application, using the flow chart shown in FIG. 16.

Initially, in a step S1, the user selects an image file to be edited. This selection is carried out by inputting a file name with path in the area 201 on the GUI window 200 shown in FIG. 2, for example by displaying a list of files and specifying a particular file from the list using the input device 101. Once the image file is selected, processing proceeds to a step S2 and the tone curve 251 is initialized. The initialization sets so that the input pixel value is equal to the output pixel value (that is, giving the tone curve the shape of a straight line with a slope of “1”, or, in terms of X-Y coordinates, “y=x”).

Next, processing proceeds to step S3, where the image data of the image file is converted in accordance with the current tone curve 251. The result of conversion is stored into the RAM 106. Since the post-initialization tone curve 251 maintains the equivalence of the input pixel value and the output pixel value, ultimately no conversion is performed on the selected image file. An image resulting from conversion is displayed in the image display region 202 shown in FIG. 2. It should be noted that, since the size of the image display region 202 is smaller than the size of the image, the converted image is displayed after performing a thinning out processing or a resizing processing.

Next, processing proceeds to step S4, where a histogram of the post-conversion image data is generated and displayed in the tone curve area 250. The histograms displayed in the present embodiment concern the RGB color components, with a histogram of each color displayed. FIG. 15A shows the state of the tone curve area 250 after the image file is selected and the tone curve 251 is initialized. It should be noted that the process of generating the histograms is simple. That is, the primary variables Red ( ), Green ( ) and Blue ( ) are allocated and assuming that the input pixel R, G, B components are Pr, Pg and Pb (all integers), then
Red(Pr)←Red(Pr)+1
Green(Pg)←Green(Pg)+1
Blue(Pb)←Blue(Pb)+1
and it is sufficient to obtain for all pixels.

Next, processing proceeds to a step S5, standing by for instruction input from the user. Such instruction input is determined in steps S6, S8 and S9 to be described later.

First, if it is determined that the instruction input is an instruction to change the shape of the tone curve 251, manipulate the brightness slider bar 260 or the contrast slider bar 270, or move one of lines of IN_HLT, IN_SDW, OUT_MAX and OUT_MIN lines, then processing proceeds from steps S6 to S7, where the changing of the tone curve 251 described above is performed. When the changing of the tone curve 251 is carried out, processing returns to step S3 to perform image conversion according to the post-conversion tone curve 251. As a result, a histogram is once again generated and revised. FIG. 12B shows the state of a display of the tone curve area 250 where the brightness has been increased. As shown in FIG. 12B, according to the image editing application of the present embodiment, the tone curve 251 can be changed in real time and any change in the histograms of the colors based on the results of that change in the tone curve 251 can also be displayed in real time as well.

By repeating steps S3 through S7 as described above, the user determines a desired tone curve 251.

If it is determined that the operation input in step S5 is activation of the OK button 203, the image converted at that point in time is saved in step S10. In saving the image, the saved image is written over the original image file. Alternatively, however, the file name may be changed. If changing the file name, the converted file saved under the new file name. Where it is determined that the cancel button 204 has been pressed, processing is terminated.

As described above, according to the present embodiment, in a GUI interface for adjusting the tone curve 251, by reflecting the results of adjustment by slider bar in the tone curve 251 in real time, the relation between user operation and the tone curve 251 can be seen clearly at a glance. In addition, if one of lines of IN_HLT, IN_SDW, OUT_MAX and OUT_MIN is changed, the results of such an operation is reflected in the brightness and contrast slider bars, thus enabling operation while also permitting easy perception of the type of operation that has been performed on the brightness and the contrast. Moreover, by adjusting the tone curve, the histograms of the colors also change in real time in response thereto, and therefore it is also possible to evaluate resulting changes to the image data objectively. Furthermore, it becomes possible to provide a superior user interface, in which changes in the tone curve 251 and changes in the color histograms can be ascertained without a change in point of view.

As is clear from the present embodiment, the present invention is adapted to a computer program that executes on an ordinary computer such as a personal computer or the like. Moreover, typically, the computer program is stored on a computer-readable storage medium such as a CD-ROM or the like. That storage medium is then set into a drive of the computer and either copied to the system or installed, and executed, and thus such computer-readable storage medium is of course within the scope of the present invention.

Moreover, the GUI described in the present embodiment is but one example of the present invention, and is not limited to the specific embodiment described above.

According to the present invention as described above, where the slider bar is manipulated the results of that manipulation are reflected in the conversion curve in real time. Furthermore, where the index axes that define the conversion are changed directly, the state of the slider bars are changed based on the results thereof, so that exactly how the results of direct adjustment of the index axes have affected the brightness and contrast can be grasped objectively.

As can be understood by those of ordinary skill in the art, a computer program executing the steps of the method and implementing the functions of the system described above is within the scope of the present invention. Moreover, because such a computer program can be executed by setting a computer-readable storage medium storing such a computer program (such as a memory card, a CD-ROM or the like) into a computer or by copying or installing same to a system of which the computer is a part, the computer-readable storage medium also is within the scope of the present invention.

As many apparently widely different embodiments of the present invention can be made without departing from the spirit and scope thereof, it is to be understood that the invention is not limited to the specific preferred embodiments described above thereof except as defined in the claims.

### CLAIM OF PRIORITY

This application claims priority from Japanese Patent Application No. 2004-020386 filed on Jan. 28, 2004, which is hereby incorporated by reference herein.

1. An image processing apparatus comprising:
conversion curve display means for displaying a conversion curve showing a relation between an input image value and an output image value in a predetermined display area;
first adjustment means for adjusting the conversion curve using a slider bar provided outside the display area and revising a displayed conversion curve;
second adjustment means for adjusting the conversion curve by changing the position of one of a plurality of index axes, inside the display area, defining the conversion curve and updating the displayed conversion curve; and
revision means for revising a slider bar state based on the conversion curve if the conversion curve is adjusted by said second adjustment means.

2. The image processing apparatus according to claim 1, wherein the slider bar includes a brightness slider bar that adjusts brightness and a contrast slider bar that adjusts contrast.

3. The image processing apparatus according to claim 1, wherein the index axes include an output pixel maximum value axis that sets an upper limit on an output pixel value, a output pixel minimum value axis that sets a lower limit on the output pixel value, a highlight axis that sets the output pixel value to an output pixel maximum value if the output pixel value exceeds the output pixel maximum value, and a shadow axis that sets the output pixel value to an output pixel minimum value if the output pixel value is less than the output pixel minimum value.

4. An image processing method comprising:
a conversion curve display step of displaying a conversion curve showing a relation between an input image value and an output image value in a predetermined display area;
a first adjustment step of adjusting the conversion curve using a slider bar provided outside the display area and revising a displayed conversion curve;
a second adjustment step of adjusting the conversion curve by changing the position of one of a plurality of index axes, inside the display area, defining the conversion curve and updating the displayed conversion curve; and
a revision step of revising a slider bar state based on the conversion curve if the conversion curve is adjusted in said second adjustment step.

5. A computer program for functioning as an image processing apparatus, the apparatus comprising:
conversion curve display means for displaying a conversion curve showing a relation between an input image value and an output image value in a predetermined display area;
first adjustment means for adjusting the conversion curve using a slider bar provided outside the display area and revising a displayed conversion curve;
second adjustment means for adjusting the conversion curve by changing the position of one of a plurality of index axes, inside the display area, defining the conversion curve and updating the displayed conversion curve; and
revision means for revising a slider bar state based on the conversion curve if the conversion curve is adjusted by said second adjustment means.

6. A storage medium storing the computer program according to claim 5.

7. An image processing apparatus for adjusting contrast and brightness, comprising:
input means for inputting image data targeted for conversion;
display means for displaying, in a predetermined display area, an initial state of a conversion curve in which a relation between an input pixel value and an output pixel value is such that the input pixel value and the output pixel value are equal, and displaying, in the display area, histograms of color components of an image obtained by conversion according to the conversion curve together with the conversion curve;
first adjustment means for using a slider bar provided outside the display area to adjust the conversion curve and revise a displayed conversion curve;
second adjustment means for adjusting the conversion curve by changing the position of one of a plurality of index axes, inside the display area, defining the conversion curve and updating the displayed conversion curve; and
revision means for revising a slider bar state based on the conversion curve if the conversion curve is adjusted by the second adjustment means,
wherein each time the conversion curve is adjusted by said first or second adjustment means, both a conversion of an image according to a post-adjustment conversion curve and the histograms are revised.

8. An image processing method for adjusting contrast and brightness, comprising:
an input step of inputting image data targeted for conversion;
a display step of displaying, in a predetermined display area, an initial state of a conversion curve in which a relation between an input pixel value and an output pixel value is such that the input pixel value and the output pixel value are equal, and displaying, in the display area, histograms of color components of an image obtained by conversion according to the conversion curve together with the conversion curve;
a first adjustment step of adjusting the conversion curve using a slider bar provided outside the display area and revising a displayed conversion curve;
a second adjustment step of adjusting the conversion curve by changing the position of one of a plurality of index axes, inside the display area, defining the conversion curve and updating the displayed conversion curve; and
a revision step of revising a slider bar state based on the conversion curve if the conversion curve is adjusted in said second adjustment step,
wherein each time the conversion curve is adjusted in said first or second adjustment steps, both a conversion of an image according to a post-adjustment conversion curve and the histograms are revised.

9. A computer program that functions as an image processing apparatus for adjusting brightness and contrast by causing a computer to read and execute the program, the apparatus comprising:
an input step of inputting image data targeted for conversion;
a display step of displaying, in a predetermined display area, an initial state of a conversion curve in which a relation between an input pixel value and an output pixel value is such that the input pixel value and the output pixel value are equal, and displaying, in the display area, histograms of color components of an image obtained by conversion according to the conversion curve together with the conversion curve;
a first adjustment step of adjusting the conversion curve using a slider bar provided outside the display area and revising a displayed conversion curve;
a second adjustment step of adjusting the conversion curve by changing the position of one of a plurality of index axes, inside the display area, defining the conversion curve and updating the displayed conversion curve; and
a revision step of revising a slider bar state based on the conversion curve if the conversion curve is adjusted in said second adjustment step;
wherein each time the conversion curve is adjusted in the first and second adjustment steps, both a conversion of an image according to a post-adjustment conversion curve and the histograms are revised.

10. A storage medium storing the computer program according to claim 9.
